(19) United States
(12) Patent Application Publication
(10) Pub. No.: US 2015/0360861 A1
(43) Pub. Date: Dec. 17, 2015

(54) Lawn and Leaf Pocket Bag

(71) Applicant: Thomas Vincent, Atlanta, GA (US)

(72) Inventor: Thomas Vincent, Atlanta, GA (US)

(21) Appl. No.: 14/302,421

(22) Filed: Jun. 11, 2014

(51) Int. Cl. B65F 1/00

(52) U.S. Cl. CPC B65F 1/002; B65F 2250/108; B65F 2220/1063

(57) ABSTRACT

A lawn and leaf bag that converts into a bag and pocket configuration or bin that allows user to rake or sweep leaves or yard debris directly into bag and pocket configuration without having to manually place leaves into bag by hand. The lawn and leaf bag is converted into a bag and pocket configuration by placing the bag on the ground on its side with the side opening facing upward or skyward and by then folding the left and right bag walls downward at an angle and pulling them outward to form sidewalls, back wall and floor of the bag and pocket configuration. After creating the bag and pocket configuration the user then sweeps or rakes leaves or debris into the configuration and once filled the configuration is then sealed and placed upright for disposal.

This Non-provisional application is a continuation in part of Provisional Application No. 61/833,809 filed on Jun. 11, 2013 entitled “Lawn and Leaf Pocket Bag”.

### FIELD OF THE INVENTION

The present invention relates to a lawn and leaf bag that converts into a leaf and lawn debris bin or bag and pocket configuration with the bag itself having an open top, one sealed gusseted side, a side with a side opening and flap and a closed triangular or diamond shaped bottom. The Lawn and Leaf Pocket Bag after being converted into a leaf and lawn debris bin is used to rake leaves and lawn debris directly into bag without having to manually place leaves or debris into bag by hand. Also, the Lawn and Leaf Pocket Bag can be used inside as well as outside as an adjustable recycling bin. The Lawn and Leaf Pocket Bag as a recycling bin allow user to adjust the height of bag by rolling up or down sides while bag is in upright position so that items like glass can be carefully placed within bag and allows children to place items in the bag or recycling bin.

Further, the Lawn and Leaf Pocket Bag can be used as a temporary adjustable trash can for parties, barbecues or family or social gatherings or used for travel or around the home as a temporary hamper.

Moreover, the user can place a plastic bag inside Lawn and Leaf Pocket Bag and adjust the height to the height of the Lawn and Leaf Pocket Bag to the height of the plastic bag.

In addition, the Lawn and Leaf Pocket Bag is ideal for camping or for use in motor home, RV or boat in that it can be easily transported without taking up a lot of space (a space saver). The Lawn and Leaf Pocket Bag comes folded flat before it is let out into a bag and once it is in bag form the height of the bag can be adjusted.

Further, it can be used for construction like a paper construction bag that converts into an open trash bin with the inner portion of the bag coated with a poly or wax coating that helps strengthen the bag against tears or the bag can be made of wet strength paper.

### BACKGROUND OF THE INVENTION

There are many types of lawn and leaf bags on the market that simply store leaves, yard trimmings and debris for disposal or composting which all require that the user manually load the leaves, yard trimmings and debris into the bag by hand. Most times these bags require the user to use bag holders to help hold the bag up and to help keep the mouth of the bag open while filling the bag or require use of tools such as leaf scoopers or leaf funnels to help aid in filling these bags. Also, most lawn and leaf bags especially those made of paper tend to tear or collapse while being filled. There are other tools and apparatus on the market that allow the user to sweep or rake debris within it such as U.S. Pat. No. 7,520,546 by Monahan but leave the user having to pick up a bulky mat that leaves the user with the possible issue of a collapsing bag or bag tear or U.S. Pat. No. 4,434,829 by Barnard in which a pan like device is used to collect leaves that uses rods and slats which make it bulky and difficult to store which normally would pose a problem concerning shipping, packaging and shelf space with retailers.

Although U.S. Pat. No. 7,520,546 by Monahan and U.S. Pat. No. 4,434,829 by Barnard both allow the leaf apparatus or device to lie on the ground while being filled they are not capable of standing upright and are not disposable or lightweight and require the user to unload the debris into another bag or another container to dispose of contents unlike the Lawn and Leaf Pocket Bag which not only allows the user to have a lightweight leaf or debris bin to rake or sweep leaves and debris, but it also converts into a self-standing bag that allows the user to have an actual bag for disposal so that the user does not have to find another container or bag to dump the leaves or debris.

Further, How it works is the Lawn and Leaf Pocket Bag is placed on its side on the ground with the side opening facing skyward or upward which allow the bag to be opened through its side opening and the right and left walls of the bag are folded backward at an angle to form the sidewalls and the sidewalls are pulled outward to form the back wall and floor of the bag and pocket configuration.

Once the bag and pocket configuration is set up the leaves and yard debris can then be raked or swept directly into bag or pocket configuration and once filled is then sealed by unfolding and bringing the left and right sidewalls together and sealing them by peeling off the glue paper from the side flap which exposes the tape or adhesive underneath and then by pressing the sidewalls together from one end to the other the side opening is then sealed. The top opening is then sealed by pulling left and right bag wall together and rolling top of the bag down into a series of folds.

Furthermore, the Lawn and Leaf Pocket Bag can be packaged with one or more bags each individually folded flat to be fitted into a sleeve that has one or more open ends. The Lawn and Leaf Pocket Bag can be made of recycled or recyclable or biodegradable material or all or a combination of these materials but preferably out of paper or plastic. Also, as mentioned earlier the Lawn and Leaf Pocket Bag can be used as an adjustable recycling bin, hamper or trash can.

### SUMMARY OF THE INVENTION

The present invention relates to the need of individuals to be able to quickly and more efficiently bag their leaves, lawn debris and yard trimmings. The Lawn and Leaf Pocket Bag saves the user a step or two by allowing the user to bypass having to manually stuff the bag which is the most tedious part of the process of bagging leaves. The Lawn and leaf Pocket Bag allow the user to rake or sweep leaves and lawn debris directly into the bag without having to pick up or load leaves by hand. The user simply sweeps, rake or dump debris into the bag and pocket configuration created from the lawn bag without having to worry about the lawn bag tearing or collapsing while being filled thus saving time, energy and bags.

Further, the bag and pocket configuration is filled while lying on the ground on its side to create stability so the user does not have to use tools such as leaf funnel or leaf scoopers to manually fill the bag. Once the bag is filled and sealed it is set upright and placed for disposal or composting.

Finally, other uses for the Lawn and Leaf Pocket Bag is that it can be used as an adjustable temporary clothes hamper, recycling bin, trash can or as a yard sled to carry small tools or lawn and gardening items.

### BRIEF DESCRIPTION OF DRAWINGS

FIG. 1 is a perspective view of the Lawn and Leaf Pocket Bag showing a side flap with adhesive and glue paper and side opening, an open top, and a gusseted side.

FIG. 2 is a perspective view of the Lawn and Leaf Pocket Bag showing how the bag bottom looks before it is brought together and formed in the shape of a triangle. It is understood that this is just an illustration of how the bag bottom can be constructed during the manufacturing process.

FIG. 3 is a perspective view of the Lawn and Leaf Pocket Bag lying on its side and shows how bag bottom looks once it is glued together with dotted lines representing the underlying parts of the bag.

FIG. 4 is an illustrative view of the Lawn and Leaf Pocket Bag transforming into the bag and pocket configuration with the upper parts of the bag walls folded downward to form the right and left sidewalls and back wall.

FIG. 5 is an illustrative side view of the bag and pocket configuration completely formed and show how the sidewalls and back wall are formed when the upper bag walls are pulled downward at an angle and how the floor is formed when the sidewalls are pulled outward.

FIG. 6 is an illustrative back view of the bag and pocket configuration.

FIG. 7 is an illustrative front view of the bag and pocket configuration with glue paper slightly peeled and sidewalls being pulled inward to begin sealing the side opening of bag to convert configuration back to bag.

FIG. 8 is an illustrative view of the bag and pocket configuration converted back to lawn bag.

FIG. 9 is an illustrative view of the Lawn and Leaf Pocket Bag in upright position.

FIG. 10 is an illustrative view of how the top opening of the Lawn and Leaf Pocket Bag is sealed by bringing the bag walls together and then rolling top of the bag downward into a series of folds.

FIG. 11 is an illustrative view of how the Lawn and Leaf Pocket Bag in upright position can be used as an adjustable hamper, recycling bin or trash can by folding or rolling down or up the walls of the bag.

FIG. 12 is an illustrative view of how the Lawn and Leaf Pocket Bag can be folded flat for packaging purposes.

FIG. 13 is an illustrative view of how the Lawn and Leaf Pocket Bag can be folded flat and slid into a sleeve for packaging purposes.

FIG. 14 is an illustrative view of how the Lawn and Leaf Pocket Bag can be made without a side flap and shows how adhesive or seal would seal side opening.

### DETAILED DESCRIPTION OF THE EMBODIMENTS

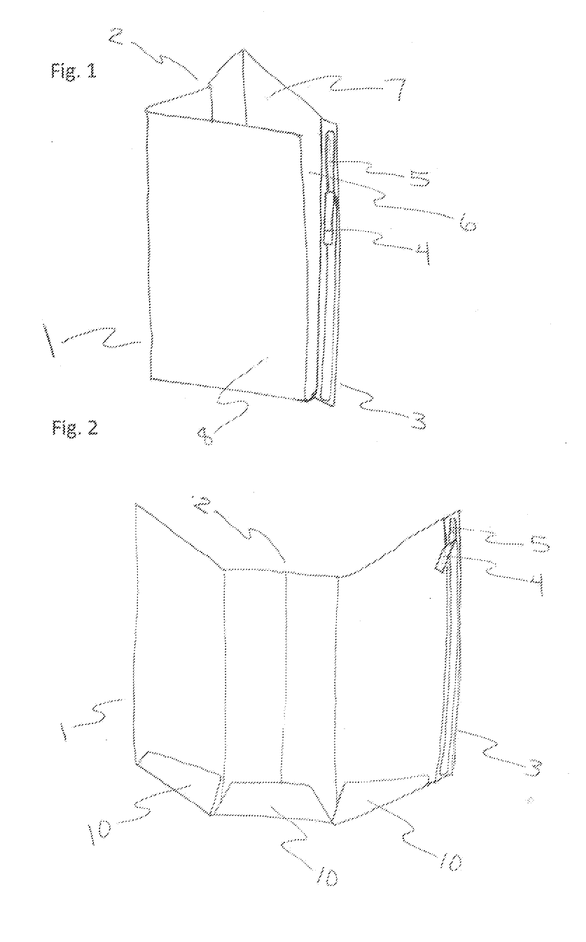

FIG. 1 is a perspective view of the Lawn and Leaf Pocket Bag 1 in upright position which is composed of recyclable or biodegradable plastic or paper which shows a side opening 6 with flap 3 that shows glue paper 4 slightly peeled back to show adhesive 5 underneath. Also, shows an open top 7 or mouth and a gusseted side 2.

FIG. 2 is a perspective view of the Lawn and Leaf Pocket Bag 1 showing how the bag bottom looks before the bottom folds 10 of the bag 1 are brought together and glued to form the shape of a triangle.

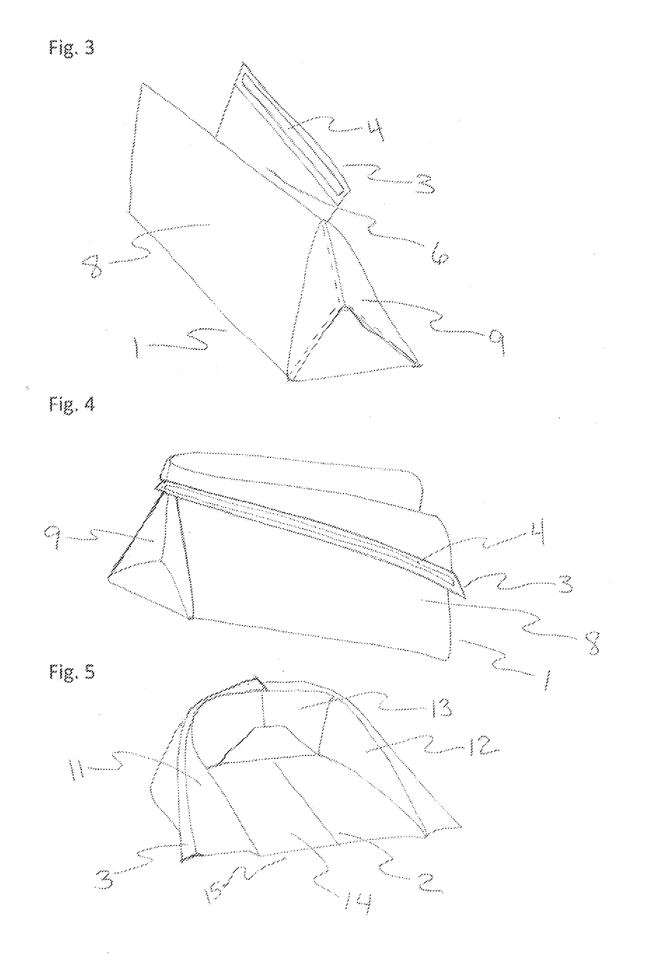

FIG. 3 is a perspective of the Lawn and Leaf Pocket Bag 1 lying on its side and shows how the bag bottom 9 looks once it is glued with dotted lines representing the underlying parts of the bag 1.

FIG. 4 is an illustrative view of the Lawn and Leaf Pocket Bag 1 beginning to form the bag and pocket configuration 15 with upper parts of the bag walls 8 folded downward to form the right 12 and left 11 sidewalls and back wall 13.

FIG. 5 is an illustrative view of the bag and pocket configuration 15 completely formed and shows how the side wall 11 and sidewall 12 and back wall 13 are formed when sidewall 11 and sidewall 12 are pulled outward.

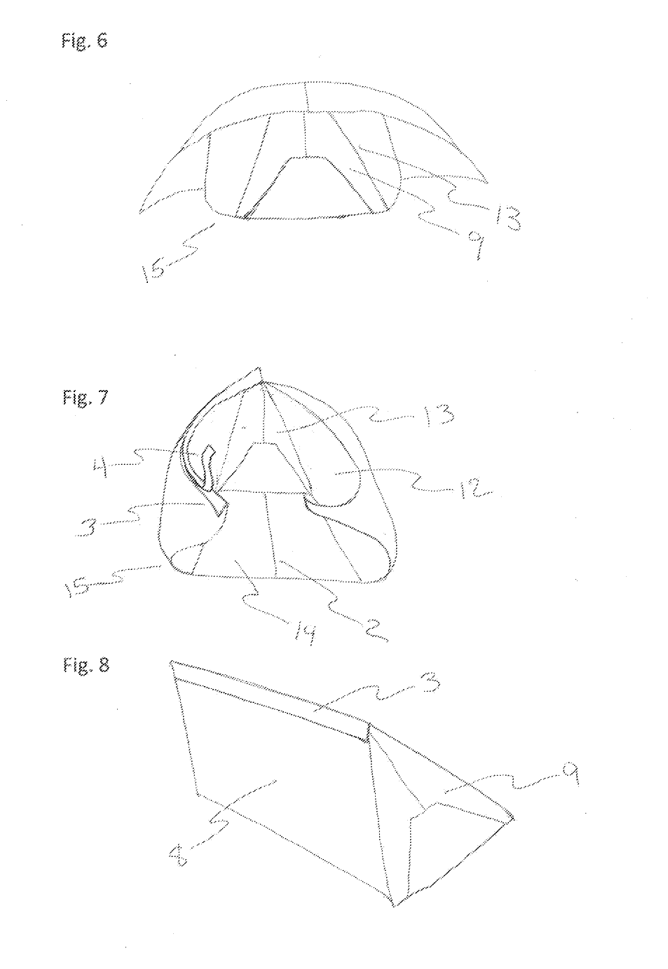

FIG. 6 is an illustrative back view of the bag and pocket configuration 15.

FIG. 7 is an illustrative front view of the bag and pocket configuration 15 with glue paper 4 slightly peeled back and sidewall 11 and sidewall 12 being pulled inward to begin sealing the side opening 6 of bag 1 to convert configuration 15 back to bag 1 after bag is filled.

FIG. 8 is an illustrative view of the bag and pocket configuration 15 converted back to bag 1.

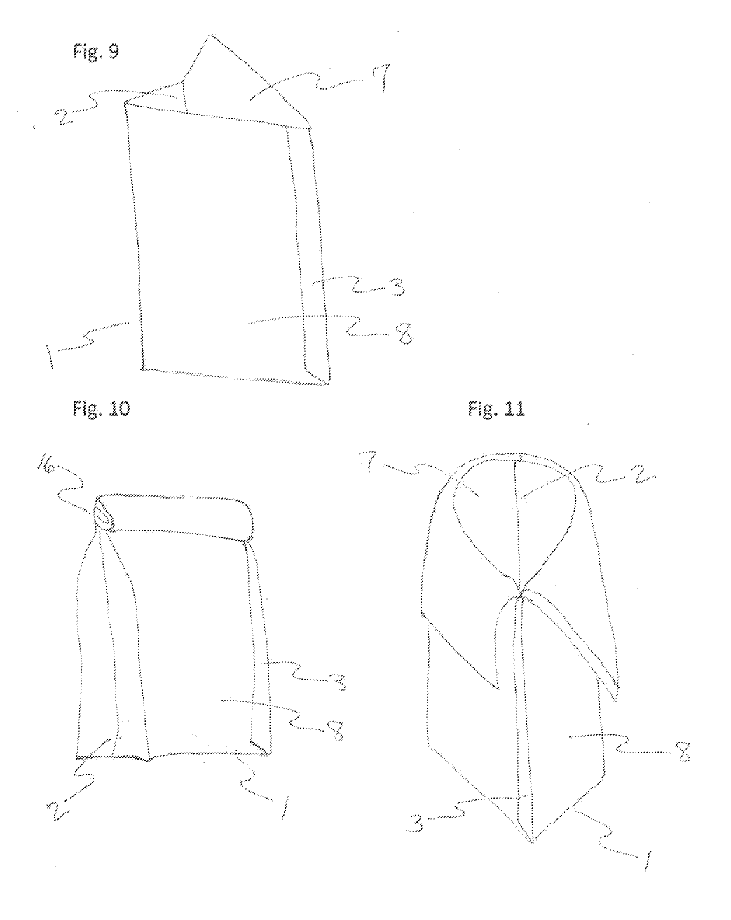

FIG. 9 is an illustrative view of the Lawn and Leaf Pocket Bag 1 in upright position.

FIG. 10 is an illustrative view of how the top opening 7 of the Lawn and Leaf Pocket Bag 1 is sealed by pulling the bag walls 8 together around top opening 7 and then rolling the top opening 7 of bag 1 downward into a series of folds 16.

FIG. 11 is an illustrative view of how the Lawn and Leaf Pocket Bag 1 in upright position can be used as an adjustable hamper, recycling bin or trash can by folding down or up the walls 8 of the bag 1.

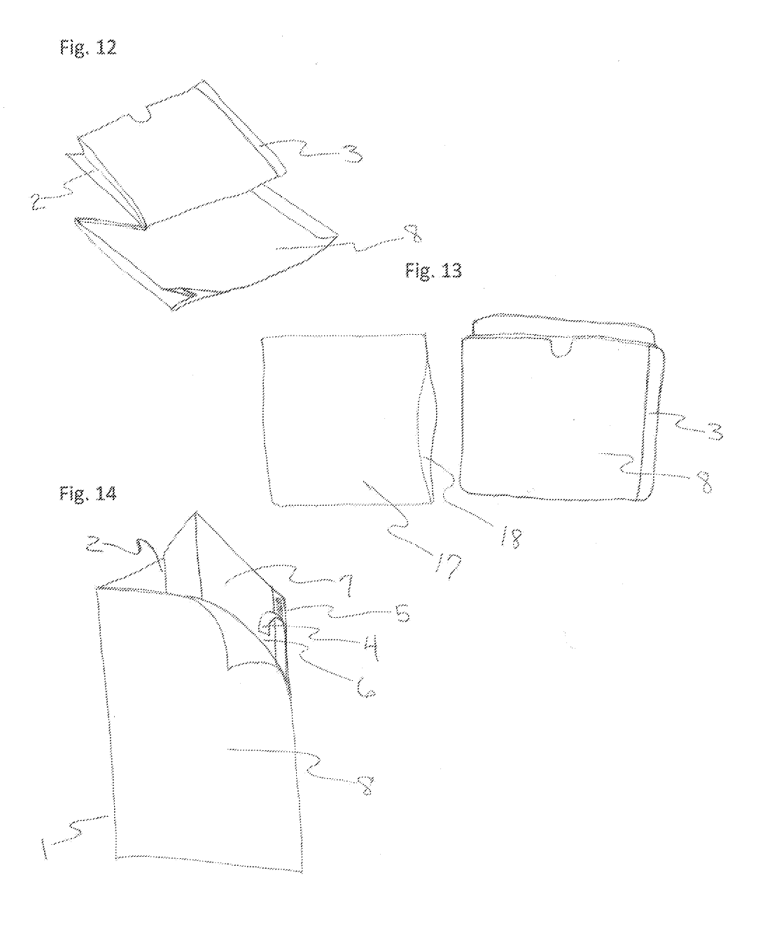

FIG. 12 is an illustrative view of how the Lawn and Leaf Pocket Bag 1 can be folded flat for packaging purposes.

FIG. 13 is an illustrative view of how the Lawn and Leaf Pocket Bag 1 can be folded flat and slid into a sleeve 17 that has one or more open ends or sleeve openings 18 for packaging purposes.

FIG. 14 is an illustrative view of how the Lawn and Leaf Pocket Bag 1 can be made without a flap 3 to cover side opening 6. It shows how glue paper 4 is peeled away from sealant or adhesive 5 so that the bag walls 8 can be sealed together to seal side opening 6.

Further, it should be understood that the foregoing pertains to the preferred embodiments described herein without departing from the spirit and scope of the invention as defined in the following claims.

I claim:

1. A lawn and leaf bag that has a closed triangular bottom, one sealed gusseted side, a front side and a back side, an open top and a side opening that allow the lawn and leaf bag to convert into a bag and pocket configuration.

2. A lawn and leaf bag that has a side opening that can be converted into a bag and pocket configuration as recited in claim 1; wherein lawn and leaf bag can be made of paper.

3. A lawn and leaf bag that has a side opening that can be converted into a bag and pocket configuration as recited in claim 1; wherein lawn and leaf bag can be made of biodegradable paper.

4. A lawn and leaf bag that has a side opening that can be converted into a bag and pocket configuration as recited in claim 1; wherein lawn and leaf bag can be made of recycled paper.

5. A lawn and leaf bag that has a side opening that can be converted into a bag and pocket configuration as recited in claim 1; wherein lawn and leaf bag can be made of plastic.

6. A lawn and leaf bag that has a side opening that can be converted into a bag and pocket configuration as recited in claim 1; wherein lawn and leaf bag can be made of recycled plastic.

7. A lawn and leaf bag that has a side opening that can be converted into a bag and pocket configuration as recited in claim 1; wherein lawn and leaf bag can be made of biodegradable plastic.

8. A lawn and leaf bag that has a side opening that can be converted into a bag and pocket configuration as recited in claim 1; wherein lawn and leaf bag can be made of nylon.

9. A lawn and leaf bag that has a side opening that can be converted into a bag and pocket configuration as recited in claim 1; wherein side opening can be made with a flap.

10. A lawn and leaf bag that has a side opening that can be converted into a bag and pocket configuration where side opening can be made with a flap as recited in claim 9; wherein flap can be made with a sealant to seal side opening.

11. A lawn and leaf bag that has a side opening that can be converted into a bag and pocket configuration where side opening can be made with a flap as recited in claim 9; wherein flap can be made with a biodegradable sealant to seal side opening.

12. A lawn and leaf bag that has a side opening that can be converted into a bag and pocket configuration where side opening can be made with a flap as recited in claim 9; wherein flap can be made with a seal to seal side opening.

13. A lawn and leaf bag that has a side opening that can be converted into a bag and pocket configuration as recited in claim 1; wherein side opening can be made with a seal to seal side opening.

14. A lawn and leaf bag that has a side opening that can be converted into a bag and pocket configuration as recited in claim 1; wherein the walls of the lawn bag in upright position can be made adjustable to roll upward and downward.

15. A lawn and leaf bag that has a side opening that can be converted into a bag and pocket configuration as recited in claim 1; wherein bag and pocket configuration is a bin for the collection of leaves and yard debris or trash.

16. A lawn and leaf bag that has a side opening that can be converted into a bag and pocket configuration as recited in claim 1; wherein the bag walls of bag are folded downward at an angle and pulled outward to help create the right and left sidewalls, back wall and floor of the bag and pocket configuration.

17. A lawn and leaf bag that has a side opening that can be converted into a bag and pocket configuration as recited in claim 1; wherein top opening is sealed by pulling bag walls inward and together with bag in upright position and then rolling bag downward into a series of folds.

18. A lawn and leaf bag that has a side opening that can be converted into a bag and pocket configuration as recited in claim 1; wherein lawn and leaf bag can be made to fold flat for packaging purposes.

19. A lawn and leaf bag that has a side opening that can be converted into a bag and pocket configuration as recited in claim 1; wherein lawn and leaf bag can be made to fit into a sleeve casing that has one or more open ends.

20. A lawn and leaf bag that has a side opening that can be converted into a bag and pocket configuration as recited in claim 1; wherein bag and pocket configuration can be used as sled to carry items.
